(19) United States
(12) Patent Application Publication
(10) Pub. No.: US 2020/0160340 A1
(43) Pub. Date: May 21, 2020

(54) DISTRIBUTED FRAUD DETECTION SYSTEM WITHIN MESH NETWORKS

(71) Applicant: Capital One Services, LLC, McLean, VA (US)

(72) Inventors: Austin Grant WALTERS, Savoy, IL (US); Jeremy Edward GOODSITT, Champaign, IL (US); Fardin ABDI TAGHI ABAD, Champaign, IL (US)

(73) Assignee: Capital One Services, LLC, McLean, VA (US)

(21) Appl. No.: 16/198,683

(22) Filed: Nov. 21, 2018

(51) Int. Cl. G06Q 20/40; G06Q 20/36; G06Q 20/38; G06Q 20/06; G07C 13/00

(52) U.S. Cl. CPC G06Q 20/407; G06Q 20/36; G06Q 20/3829; G06Q 20/32; G07C 13/00; G06Q 2220/00; G06Q 20/0658

(57) ABSTRACT

Techniques for handling fraudulent or erroneous transactions conducted within a mesh network using a localized cryptocurrency are provided. An electronic device can receive data from a mesh network to establish the device as a node on the mesh network. The established node can generate and store a cryptocurrency wallet that can be used to fund transactions conducted within the mesh network. The established node can detect a fraudulent or erroneous transaction and can request the transaction be reversed or reverted. In response, a recipient node involved in the transaction can implement a reversion process. If the request to revert the transaction is granted, a new wallet can be provided to the established node. Fees for processing the reversion request can be provided to nodes that facilitate the reversion process, including the recipient node.

### TECHNICAL FIELD

Embodiments described herein generally relate to a mesh network.

### BACKGROUND

During events such as festivals or at locations such as arcades and amusement parks, cash is often used for transactions. Using cash at such events or locations can increase a risk of cash being stolen or a risk of cash being skimmed by employees. Accordingly, what is needed is an alternative form of payment to facilitate transactions within a specific geographical area and/or for a specific period of time that reduces the risk associated with using cash. Further, what is needed is a mechanism for recognizing and handling unauthorized or erroneous transactions conducted using the alternative form of payment without requiring a central authority.

### SUMMARY OF THE DISCLOSURE

This disclosure presents various systems, components, and methods related to using a blockchain within a mesh network. Each of the systems, components, and methods disclosed herein provides one or more advantages over conventional systems, components, and methods.

Various embodiments include techniques for handling fraudulent or erroneous transactions conducted within a mesh network using a localized cryptocurrency. Data relating to the mesh network can be received and stored by an electronic device such as, for example, a smartphone. The electronic device can be established as a node on the mesh network based on the stored received data. The established node can generate and store a cryptocurrency wallet that can be used to fund transactions conducted within the mesh network. The established node can detect a fraudulent or erroneous transaction and can request the transaction be reversed or reverted. In response, a recipient node involved in the transaction can implement a reversion process. If the request to revert the transaction is granted, a new wallet can be provided to the established node. Fees for processing the reversion request can be provided to nodes that facilitate the reversion process, including the recipient node. In this way, suspect transactions can be monitored and addressed within the mesh network without a central authority and without the need to modify a blockchain associated with the localized cryptocurrency. Other embodiments are disclosed and described.

### BRIEF DESCRIPTION OF THE DRAWINGS

FIG. 1 illustrates an operating environment.

FIG. 2 illustrates a first logic flow.

FIG. 3 illustrates a second logic flow.

FIG. 4 illustrates a third logic flow.

FIG. 5 illustrates a storage medium.

FIG. 6 illustrates a computing architecture.

FIG. 7 illustrates a communication architecture.

FIG. 8 illustrates a logical model of a blockchain.

FIG. 9 illustrates a logical model of a message stored in the blockchain of FIG. 8.

### DETAILED DESCRIPTION

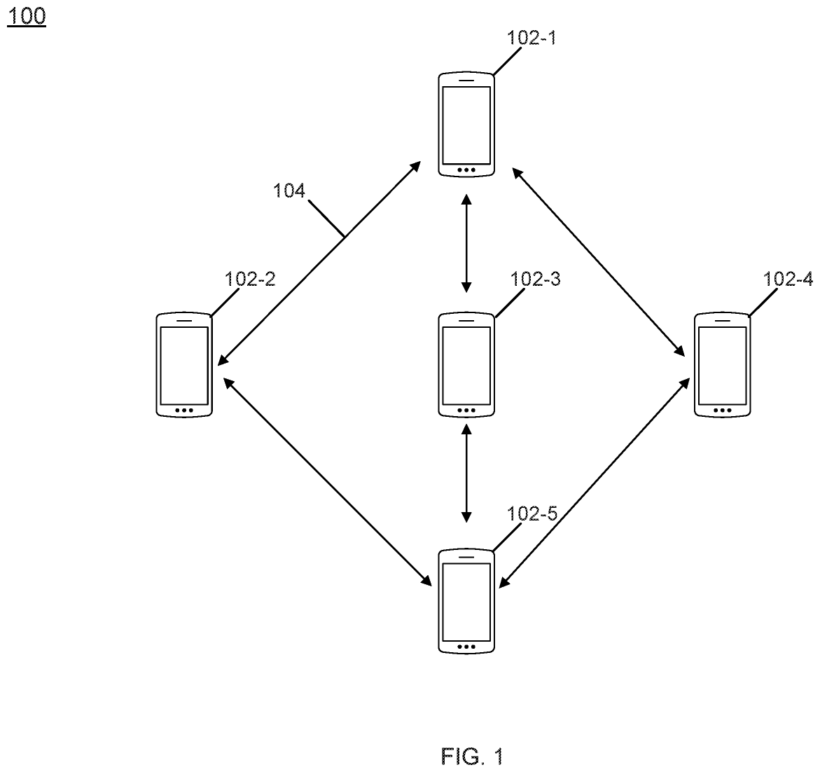

FIG. 1 illustrates an operating environment 100 such as may be representative of various embodiments in which techniques for identifying and reverting transactions may be implemented. The operating environment 100 can be a mesh network and can include a first node 102-1, a second node 102-2, a third node 102-3, a fourth node 102-4, and a fifth node 104-5 node. The mesh network 100 is not limited to the number of nodes depicted in FIG. 1.

In various embodiments, the mesh network 100 can be any type of mesh network and can operate according to any known mesh networking protocol or standard. In various embodiments, data, traffic, messages, or other communications within the mesh network 100 can be transmitted between the nodes 102 as described herein. In various embodiments, data, traffic, messages, or other communications within the mesh network 100 can be transmitted from an initial node to a desired recipient node through one or more intermediate nodes, with intermediate nodes passing communications intended for the desired recipient node to a next nearest neighbor (e.g., as determined by distance) or other node as described herein.

The mesh network 100 can be established in association to a specific event such as, for example, a music festival. In various embodiments, the mesh network 100 can be intended to be established over a restricted or limited amount of time and/or area and in relation to a specific event or venue. For purposes of discussion, the mesh network 100 can be referred to as a localized mesh network 100 to reflect the limited duration and/or geographical footprint of the localized mesh network 100.

The mesh network 100 can be provided in an area without Internet access or with limited Internet access such as, for example, a farmer's market or a festival. The mesh network 100 can provide a payment system within the mesh network 100 that does not require each node 102 to be connected directly to the Internet. In various embodiments, one or more nodes 102 can maintain a blockchain for a cryptocurrency that can support a payment system useable within the mesh network 100. In various embodiments, the blockchain and the associated cryptocurrency can be limited to use within the mesh network 100. Accordingly, the blockchain can be referred to as a localized blockchain—in that it is maintained locally and for the duration of the existence of the mesh network 100—and the cryptocurrency can be referred to as a localized cryptocurrency—in that it is useable only by participants of the mesh network 100 and for the duration of the existence of the mesh network 100.

In various embodiments, the mesh network 100 can include a central authority that maintains and pre-mines the cryptocurrency. In various embodiments, the mesh network 100 can operate without a central authority and can include one or more nodes that maintain the blockchain related to the cryptocurrency. In various embodiments, certain nodes may be allowed to fully participate on the mesh network—for example, these nodes may be able to maintain the blockchain, conduct transactions, and authorize transactions. Such nodes can be considered to be authorized nodes. In various embodiments, non-authorized nodes may be limited to transferring messages or other communication traffic between nodes on the mesh network 100.

As an example, the node 102-1 and the node 102-5 can each be considered to be an authorized node on the mesh network 100. One or more of the authorized nodes 102-1 and 102-5 can maintain the blockchain for the cryptocurrency. One or more of the authorized nodes 102-1 and 102-5 can process transactions related to the blockchain including, for example, updating the blockchain based on a transaction and distribute the updated blockchain. Transactions can be conducted within the mesh network 100 and can utilize the cryptocurrency blockchain maintained by one or more of the nodes 102-1 and 102-5. The nodes 102-1 and 102-5 can have access to the Internet and/or a remote network while the other nodes of the mesh network 100 may not have access to the Internet or any remote network.

As an alternative example, the node 102-1 can operate as a central authority that governs operation of the mesh network 100. Under such a scenario, the node 102-1 can pre-mine a certain amount of cryptocurrency for use within the mesh network 100—for example, only within the mesh network 100, by participants (nodes) within the mesh network 100, and only for the duration of the existence of the mesh network 100.

In contrast to the nodes 102-1 and 102-5, the nodes 102-2, 102-3, and 102-4 can each be considered to be an unauthorized node. In various embodiments, as unauthorized nodes, the nodes 102-2, 102-3, and 102-4 can each route communications or other messages to an authorized node (e.g., the nodes 102-1 and 102-5) but cannot directly send messages to one another (e.g., the node 102-2 cannot directly send a message to the node 102-3). In various embodiments, as unauthorized nodes, the nodes 102-2, 102-3, and 102-4 may be allowed to receive and transmit communications, messages, or other traffic on a limited basis. In various embodiments, one or more of the authorized nodes 102-1 and 102-5 can determine the allowed level of participation on the mesh network 100 by the nodes 102-2, 102-3, and 102-4.

Path 104 can represent a communication path between certain nodes on the mesh network 100 (e.g., between the node 102-1 and the node 102-2). Other paths 104 between certain nodes are shown in FIG. 1 but are not labeled for simplicity. The path 104 can indicate that communication between certain nodes is allowed or possible within the mesh network 100. In various embodiments, communications between the authorized node 102-1 and the authorized node 102-5 can be provided through the node 102-3—for example, the node 102-3 can relay messages between the authorized nodes 102-1 and 102-5. In various embodiments, a communication path is not shown between the node 102-3 and the node 102-4 since each node is unauthorized and cannot directly send messages to one another. Instead, the nodes 102-3 and 102-4 may be allowed to perform only limited functions with respect to the mesh network 100 as described herein.

In various embodiments, each of the nodes 102 can be associated with a cryptocurrency wallet that can be loaded with an amount of cryptocurrency (e.g., cryptocurrency tokens). The authorized nodes 102-1 and 102-5 can issue the cryptocurrency wallets for the other nodes 102-2, 102-3, and 102-4. The authorized nodes 102-1 and 102-5 can also control access to the mesh network 100. As an example, the authorized nodes 102-1 and 102-5 can grant or deny a request by another node 102 (e.g., the node 102-2) to join and participate on the mesh network 100. In various embodiments, only authorized nodes can be associated with a cryptocurrency wallet. In various embodiments, functions performed by authorized nodes can be reserved for a central authority.

The authorized nodes 102-1 and 102-5 can be designated as such in a number of manners. In various embodiments, a node 102 can be considered an authorized node 102 once it holds or stores a certain amount or value of cryptocurrency. In various embodiments, a node 102 can be considered an authorized node 102 once a certain number of other nodes 102 (e.g., authorized nodes) determine the node 102 should be an authorized node. In various embodiments, a node 102 can be considered an authorized node 102 once it helps facilitate a certain number of transactions using the blockchain (e.g., helps authorize transactions based on the blockchain). The number of transactions can be compared to a threshold number that when exceeded flags the node 102 as an authorized node.

In general, to become an authorized node, one or more criteria must be met as described herein. Once a node becomes an authorized node, the node can communicate in any manner with any other node of the mesh network 100, can manage participation of other nodes on the mesh network including, for example, issuing cryptocurrency wallets, and can manage a blockchain of the cryptocurrency. An authorized node can receive payments (e.g., based on the cryptocurrency) for processing transactions and maintaining the blockchain and can receive payments for routing communications and other messages through the mesh network 100.

In contrast, unauthorized nodes are generally limited to routing communications and other messages to authorized nodes. In various embodiments, unauthorized nodes can receive payments (e.g., based on the cryptocurrency) for helping to facilitate transactions within the mesh network 100—for example, by routing traffic carrying data related to a transaction toward an authorized node and by helping to authorize a transaction (e.g., when a desired cryptocurrency transaction requires authorization from multiple nodes for verification). In various embodiments, unauthorized nodes can also receive payments for routing communications and other messages through the mesh network 100 (e.g., subject to any routing limitations related to operating as an authorized node). In various embodiments, one or more of the authorized nodes 102-1 and 102-5 can be connected to the Internet and/or a remote network. In various embodiments, the one or more of the authorized nodes 102-1 and 102-5 can ensure that a maintained blockchain is up to date and accurate with versions of the blockchain maintained outside of the mesh network 100.

For purposes of illustration and explanation only, five nodes 102 are shown in FIG. 1, but the number of nodes 102 capable of operating on the mesh network 100 is not so limited as any number of nodes 102 can be included within the mesh network 100. The nodes 102 can represent any type of electronic and/or computing device maintained by an operator or user including, for example, a smartphone, a tablet, a laptop, or any other consumer electronic device capable of operating as a node 102 on the mesh network 100. The operator or user of any of the nodes 102 can be a private individual or can be a business owner or purveyor such that certain nodes 102 can represent a point of sale node (e.g., a node associated with the sale of a good or service). Accordingly, transactions can be conducted entirely within the mesh network 100 using the blockchain between a point of sale (POS) node and an individual node and/or between two individual nodes.

For purposes of discussion, operation of the node 102-2 is described in relation to joining the mesh network 100 and can be applicable to any other node 102 on the mesh network 100. In various embodiments, the node 102-2 can receive data or other information relating to the mesh network 100. In various embodiments, an application (app) or other program can be downloaded onto the node 102-2. The data or other information relating to the mesh network 100 and/or the downloaded app can be used to establish the electronic device and/or computing device as the node 102-2 on the mesh network 100. Other nodes 102 can also be established on the mesh network 100 in a similar manner.

After the computing device is established as the node 102-2 that is capable of operating on the mesh network 100, the node 102-2 can generate a cryptocurrency wallet. The generated cryptocurrency wallet can be stored on the node 102-2—for example, within a storage device and/or memory unit of the computing device established as the node 102-2. The cryptocurrency wallet for the node 102-2 can be issued by an authorized node of the mesh network such as, for example, the node 102-2 or the node 102-5.

After generating a cryptocurrency wallet, the user of the computing device operating as the node 102-2 can load the generated cryptocurrency wallet with an amount (or number) of cryptocurrency tokens. The amount (or number) of cryptocurrency tokens can be issued by an authorized node of the mesh network. As an example, the node 102-2 can provide a payment to the authorized node 102-1 in exchange for a corresponding amount of a cryptocurrency (e.g., cryptocurrency tokens). Other nodes 102 of the mesh network 100 can generate a cryptocurrency wallet and load the wallet with cryptocurrency in a similar manner.

In various embodiments, only authorized nodes are allowed to conduct financial transactions on the mesh network 100. In various embodiments, unauthorized nodes are allowed to also conduct financial transactions on the mesh network 100.

In various embodiments, the authorized node 102-1 can conduct transactions within the mesh network 100 using cryptocurrency stored in a generated wallet. As an example, the node 102-1 can initiate and conduct a transaction with the node 102-5 (e.g., for a good or service offered by the node 102-5). Payment can be provided by the node 102-1 to the node 102-5 based on cryptocurrency stored in the generated wallet of the node 102-1. One or more authorized nodes—such as the node 102-1—can update and manage the blockchain to reflect the transaction between the node 102-1 and the node 102-5. Transactional data or information can be transferred between the nodes 102-1 and 102-5 to facilitate the transaction. One or more unauthorized nodes—such as the node 102-2—can transfer messages related to the transaction between the nodes 102-1 and 102-5. In doing so, the node 102-2 can receive a payment (e.g., from the node 102-1 and/or the node 102-5) for facilitating the transaction. Over time, in various embodiments, the node 102-2 can receive enough payments for supporting transactions to meet a requirement to be considered an authorized node on the mesh network 100.

In various embodiments, the unauthorized nodes 102-2, 102-3, and 102-5 (as well as the authorized nodes 102-1 and 102-5), can transmit and receive communications and/or other messages within the mesh network 100. As an example, the node 102-2 can generate and transmit communication messages within the mesh network 100. To do so, the node 102-2 can be required to issue a payment to each node 102 that helps facilitate transmission of the generated message from the node 102-2 as it is relayed through one or more intermediate nodes before reaching a desired destination node.

Further, the node 102-2 can be required to issue a payment to each node that helps facilitate a transaction initiated by the node 102-2. For example, the node 102-2 can be required to issue a payment to the authorized node 102-1 that manages the cryptocurrency blockchain and to issue a payment to any node 102 that helps transmit any messages between nodes 102 that conduct a transaction. For example, the node 102-3 may receive payment from the node 102-2 for transferring messages—for example, messages related to a communication or messages related to a transaction—between the nodes 102-2 and the node 102-4. In this way, each node 102 on the mesh network 100 can receive payments for facilitating transactions and/or communications between other nodes 102 on the mesh network 100.

In various embodiments, messages relating to transactions can be routed to the authorized nodes 102-1 and the node 102-5 to facilitate management of the blockchain. The nodes 102-1 and 102-5 can manage the cryptocurrency blockchain and can therefore know the current state of the blockchain. The blockchain managed by the nodes 102-1 and 102-5 can be distributed within the mesh network 100 including, for example, a state of the blockchain. The nodes 102-1 and 102-5 may also provide access to remote networks and/or the Internet to facilitate communications between any of the nodes 102 and remote device operating outside of the mesh network 100. In various embodiments, as shown in FIG. 1, the unauthorized nodes 102-2, 102-3, and 102-4 can funnel or route all traffic—for example, any type of communication or transactional information—to the authorized nodes 102-1 and 102-5.

In various embodiments, the mesh network 100 can operate without being under the control of a central authority. Instead, the mesh network 100 can be facilitated by several distributed authorized nodes (e.g., the nodes 102-1 and 102-5) that manage a payment system (e.g., cryptocurrency blockchain) that can be used to conduct transactions on the mesh network 100, with other nodes on the mesh network 100 routing transactional related traffic to the authorized nodes to earn payments, and routing secure communications between nodes to also earn payment.

In various embodiments, a node 102 may join the mesh network 100 but may have limited capabilities within the mesh network 100 as regulated and controlled by the authorized nodes 102-1 and 102-5. In various embodiments, a node may only be allowed to participate on the mesh network 100 after having a certain amount of cryptocurrency stored in an associated wallet, by receiving authorization to participate from one of the authorized nodes 102-1 and 102-5, or by helping to facilitate a certain number of transactions (e.g., passing messages relating to financial transactions or verifying a requested transaction) or helping to facilitate transfer of data communications (e.g., by transferring or routing communications unrelated to a financial transaction to an authorized node).

In various embodiments, an unauthorized node can be elevated to an authorized node in a similar manner—i.e., by meeting certain criteria such as, for example, by having a certain amount of cryptocurrency stored in an associated wallet, by receiving full authorization from one of the existing authorized nodes 102-1 and 102-5, or by helping to facilitate a certain number of transactions (e.g., passing messages relating to financial transactions or verifying a requested transaction) or helping to facilitate transfer of data communications (e.g., by transferring or routing communications unrelated to a financial transaction to an authorized node).

In various embodiments, an unauthorized node—such as the node 102-2—may be limited to routing any communications or messages of any type to only authorized nodes (such as the nodes 102-1 and 102-5). In various embodiments, an authorized node—such as the node 102-1—may be able to route any communication or message of any type to any adjacent or next neighbor node—for example, a node that is in closest proximity to the node 102-1 (e.g., geographically determined or closest based on a measured distance to the node). In various embodiments, the authorized nodes 102-1 and 102-5 and/or the mesh network 100 can operate according to a proof-of-stake (POS) algorithm. The authorized nodes 102-1 and 102-5 can then operate to maintain the security of the mesh network 100 for facilitating communication within the mesh network 100 while also providing a payment system within the mesh network 100 that can be used by all participating nodes.

The payment system used within the mesh network 100 by the nodes 102 that utilizes a blockchain and related cryptocurrency can be implemented using any of the components or features described in U.S. application Ser. No. 16/182,222, filed Nov. 6, 2018, U.S. application Ser. No. 16/182,184, filed Nov. 6, 2018, and U.S. application Ser. No. 16/182,173, filed Nov. 6, 2018, each of which is hereby incorporated by reference in their entirety.

In various embodiments, the mesh network 100 and its constituent nodes 102 can operate to address transactions that are to be reversed or reverted. For example, a transaction may occur between two or more nodes 102 that is later desired to be reversed or reverted. The initial transaction can be authorized or verified by a set of nodes 102 on the mesh network 100 but then later reverted or reversed based on the request of one or more nodes that may or may not be part of the initial transaction.

In various embodiments, the initial transaction may be a fraudulent transaction and/or an unauthorized transaction. For example, a computing device of a user operating as a node 102 may be stolen by an actor that uses the cryptocurrency wallet of the stolen computing device/node 102 to conduct a transaction (e.g., purchase a good offered for sale by another node). The original owner/user of the stolen node 102 may later recover the computing device/node 102, recognize that an unauthorized transaction was performed, and may request that the unauthorized transaction be reversed or reverted. In this way, the user can attempt to recover all or a portion of the cryptocurrency funds used for the unauthorized transaction.

In various embodiments, the initial transaction may be a transaction that cannot be fully performed such that a request to revert or reverse the transaction may be requested. For example, the user of the node 102-1 may request to purchase a good from the node 102-5. As part of conducting the transaction, the node 102-1 can transfer an amount of the localized cryptocurrency to the node 102-5. After transferring cryptocurrency funds to the node 102-5, the node 102-1 can determine that the good request for purchase is no longer available. That is, the order requested by the node 102-1 cannot be fulfilled by the node 102-5 (e.g., a desired T-shirt size is no longer available). As a result, the node 102-1 may request that the requested transaction be reversed or reverted, such that the funds transferred to the node 102-5 are provided back to the node 102-1 (all or a portion of the funds as described herein). Under such a scenario, the initial transaction may not be unauthorized but may be considered to be accidental, mistaken, or desired to be voided, reverted, or reversed.

To address transactions requested to be reversed or reverted, techniques described herein can be implemented by the mesh network 100 and/or its constituent nodes. As a first step, a user of a node 102 (for example, the node 102-1) can determine a transaction that the node 102-1 would like to revert or reverse. The transaction can be an unauthorized transaction or a fraudulent transaction (or erroneous, unfillable, mistaken, etc.). The transaction can be related to a transaction that, without any malicious intent, cannot be properly fulfilled (e.g., due to lack of inventory) or may be accidental (e.g., user of node 102-1 accidentally purchased an item the user does not actually want). The node 102-1 can determine that a certain amount of cryptocurrency funds from a cryptocurrency wallet associated with the node 102-1 can be involved in the transaction. For example, the node 102-1 may determine that a first amount of cryptocurrency (e.g., cryptocurrency funds or tokens) can be removed from the cryptocurrency wallet to conduct the transaction. The original wallet of the node 102-1 that was used to fund the transaction that is subject to the reversion request can be considered to be an initial cryptocurrency wallet.

After determining a transaction to be reversed or reverted, the node 102-1 can communicate with the other node 102 (e.g., the node 102-5) that was party to the transaction. The node 102-5 can be, for example, a POS node that operates as a vendor at a localized event where the mesh network 100 operates. The node 102-1 can communicate to the node 102-5 that a request to revert or reverse the transaction is being issued. The node 102-1 may determine the identity of the node 102-1 in a variety of manners including, for example, by reviewing the blockchain maintained in the mesh network 100 to determine parties to transactions involving the wallet of the node 102-1. Overall, the node 102-1 communicates to the node 102-5—which can be the node that received cryptocurrency funds from the node 102-1 in relation to the transaction—a desire to have the transaction reversed or reverted.

In various embodiments, for purposes of explanation, the node 102-1 requesting reversion of a transaction can be considered to be a sender of the transaction. The node 102-5 that was on the receiving end of the transaction and cryptocurrency funds can be considered to be a recipient of the transaction. The node 102-1 and/or the node 102-5 can initiate a transaction reversion process. In various embodiments, the node 102-5 can be required to initiate the transaction reversion process. As part of the reversion process, the node 102-1 and/or the node 102-5 can request that a set of nodes 102 confirm reversion of the transaction. The set of nodes 102 can be any set of nodes and any number of nodes. In various embodiments, the set of nodes 102 can include two to seven nodes 102. In various embodiments, the set of nodes 102 can implement a confirmation or authorization to revert the transaction. The set of nodes 102 can be the same set of nodes that authorized or verified the original initial transaction that the node 102-1 is requested to have reversed or reverted. In various embodiments, the set of nodes 102 can be the set of nodes 102 that each performed a portion of the hashing used to create the cryptocurrency wallet of the node 102-1.

In various embodiments, the set of nodes 102 can provide a vote whether to allow or disallow the requested reversion. The vote of each node in the set of nodes 102 can be communicated to any other node 102 of the mesh network 100. The set of nodes 102 can determine a vote to revert or to not revert based on any factor or input. In various embodiments, the recipient node 102-5 can also provide a vote or can provide a communication to any other node 102 of the mesh network 100 indicating whether the node 102-5 agrees with or disagrees with reverting the transaction.

In various embodiments, the set of nodes 102 can base a vote on a score or rating of the node 102-1. The score of rating of the node 102-1 can be based on a level of trustworthiness of the node 102-1 (e.g., a determined level of trust). A higher score, indicating higher levels of trustworthiness, can be given to the node 102-1 if the node 102-1 is involved with a relatively low number of questionable or revertible (or requested revertible) transactions. A lower score, indicating lower levels of trustworthiness, can be assigned to the node 102-1 if the node is involved with a relatively high number of questionable of revertible (or requested revertible) transactions. The score assigned to the node 102-1 can be a uniform score assigned (e.g., averaged) by any set of nodes 102 of the mesh network 100. In various embodiments, each node 102 in the mesh network 100 can maintain its own scoring for any other node of the mesh network 100 based on any criteria such as, for example, number of transaction in which a node 102 is involved in, amount of cryptocurrency held by a node 102, number of transactions in which the nodes 102 is involved in that are everted or requested to be reverted (whether the node is the sender or recipient of the transaction), etc.

If the set of nodes 102 decide not to revert the transaction (e.g., based on a majority of votes provided by the set of nodes indicating they do not agree to reverting the transaction), then such a result can be communicated to the node 102-1 and the original transaction can remain unaltered. Alternatively, if the set of nodes 102 decide to revert the transaction, then such a result can be communicated to any other node 102 operating within the mesh network including the nodes 102-1 and 102-5. The set of nodes can then create a new cryptocurrency wallet for the node 102-1. The new wallet can be created by each node 102 within the set of nodes 102 performing a portion of the hashing used to create the new wallet. Each node can perform a portion of the hashing in sequence. That is, the new wallet—which can be considered to be a replacement cryptocurrency wallet—can be created by hashing operations conducted by the set of nodes 102. In various embodiments, the hashing operations can be performed sequentially with each node 102 in the set of nodes 102 hashing an output provided by another node 102 in the set of nodes 102 until a last node 102 performs a final hashing operation.

After the new wallet is created, the recipient node 102-5 is informed a new wallet has been created for the node 102-1. The recipient node 102-5 can then confirm the new wallet and the recipient of the new wallet (e.g., the node 102-1). In various embodiments, the recipient node 102-5 can confirm issuance of the replacement wallet to the node 102-5. The new wallet can then be provided to the node 102-1. A new secret (e.g., private key) can also be provided to the node 102-1. A portion of the key can be provided by each node 102 within the set of nodes 102 that generated the wallet. The replacement key can be considered to be a replacement secret key associated with the replacement wallet.

The new wallet established for the node 102-1 can include all of the funds included in the wallet prior to an amount being removed to pay for the transaction that was reverted or can include all of the funds less some portion used to cover transaction costs associated with reverting the transaction. As an example, the amount of funds used for the reverted transaction less a portion can be restored into the new wallet. The portion not restored can include various components. In various embodiments, a first component can be distributed to the set of nodes 102 that generated the new wallet for the node 102-1. The amount of funds comprising the first component can be evenly distributed among the set of nodes 102 (e.g., such that each node 102 receives an equal share of funds) or can be distributed in any manner. This first component of funds that are not restored in the new wallet can be considered to be a fraudulent processing fee paid by the node 102-1. The node 102-5 can distribute this first component of funds to the set of nodes.

A second component of funds that are not restored in the new wallet can be kept by the node 102-5. This second component of funds can be considered to be a transaction cost fee extracted by the node 102-5 for facilitating the reversion of the transaction. These first and second components of non-restored funds can total an amount that is less than the total amount of funds involved in the transaction. In various embodiments, the first and second component amounts can be fixed or variable, based on the amount of funds involved in the transaction (e.g., 5% or 10% total). Overall, the node 102-5 will receive a new wallet will the majority of the funds involved in the transaction restored but with a portion distributed as processing and transactional cost fees as described herein.

In various embodiments, the transaction subject to the reversion request can involve a first amount of localized cryptocurrency. The new or replacement wallet can include localized cryptocurrency including a second amount of the localized cryptocurrency. The first amount can be greater than the second amount. A first portion of a difference between the first amount of the localized cryptocurrency and the second amount of the localized cryptocurrency can be provided to the set of nodes 102 as a fee for reverting the transaction, as described herein. A second portion of the difference between the first amount of the localized cryptocurrency and the second amount of the localized cryptocurrency can provided to the second node, as described herein, as a processing fee for overseeing or managing the reversion process.

The techniques described herein enable a cryptocurrency to be set up within a localized mesh network for use within a specific period of time and over a specific geographical area. The cryptocurrency can be used by participants of the mesh network to conduct transactions. The techniques described herein also allow fraudulent, unauthorized, mistaken, erroneous, or unfillable transactions to be detected and addressed with or without the use of a central authority. Further, such transactions can be reversed without requiring an associated blockchain to be modified or rebuilt but rather by addressing changes to a wallet of a participant requesting the transaction reversions. The requesting participant may be required to pay relatively small transaction and/or processing fees to participants wither affected by the transaction reversal or participants aiding the processing related to the reversal of the transaction. The relatively small fees represent a small downside to reversing the transaction that often in other conventional cryptocurrency systems or mesh networks cannot be adjusted at all. Transactions involving the prior wallet (e.g., a compromised wallet used to fund the reverted transactions) may be blocked from conducting further transactions.

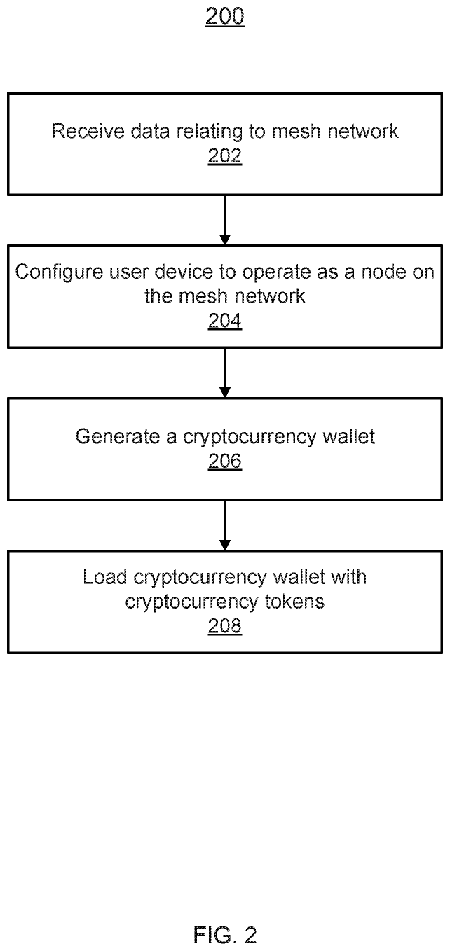

FIG. 2 illustrates an example of a logic flow 200 that may be representative of techniques for enabling a computing device (or electronic device) of a user to operate as a node on a mesh network and to generate a cryptocurrency wallet to facilitate use of cryptocurrency tokens. For example, the logic flow 200 may be representative of operations that may be performed in various embodiments by any constituent component of the mesh network 100 (e.g., any of the nodes 102 such as the node 102-1) depicted in FIG. 1.

At 202, the computing device of the user can receive data relating to a mesh network. The computing device can store the received data in a storage device (e.g., a memory component) of the computing device. The computing device can be, for example, a smartphone. The user can be, for example, an attendee of an event or visitor of a venue associated with the mesh network. The mesh network can be, for example, the mesh network 100. The event or venue can be, for example, a farmer's market or a festival having limited or no Internet access. In various embodiments, the user can download an app to her smartphone. The app can include or can be used to receive the data relating to the mesh network

At 204, the computing device can be configured to operate as a node on the mesh network 100 based on the stored received data. In various embodiments, the downloaded app can be used to establish the smartphone as capable of operating as a node on the mesh network (e.g., as the node 102-1). At 204, the node 102-1 can operate within the mesh network 100.

At 206, the node can generate a cryptocurrency wallet. The cryptocurrency wallet can be stored in the storage device of the node. The cryptocurrency wallet can be issued by an authorized node of the mesh network. As an example, the node 102-5 can authorize and issue the cryptocurrency wallet of the node 102-1.

At 208, the node can load the generated cryptocurrency wallet with an initial amount of cryptocurrency tokens. The initial amount of cryptocurrency tokens can be loaded into the generated cryptocurrency wallet by direct interaction with an authorized node of the mesh network. For example, the node 102-1 can provide a payment directly to the authorized node 102-5 such that the authorized node 102-5 issues a corresponding amount of cryptocurrency (e.g., cryptocurrency tokens) to the node 102-1.

In various embodiments, at 208, the node 102-1 can be considered to be an authorized node based on the amount of cryptocurrency loaded into the wallet of the node 102-1. For example, the amount of cryptocurrency can exceed a predetermined threshold (e.g., a threshold amount) that is required to ensure a node will be considered to be an authorized node.

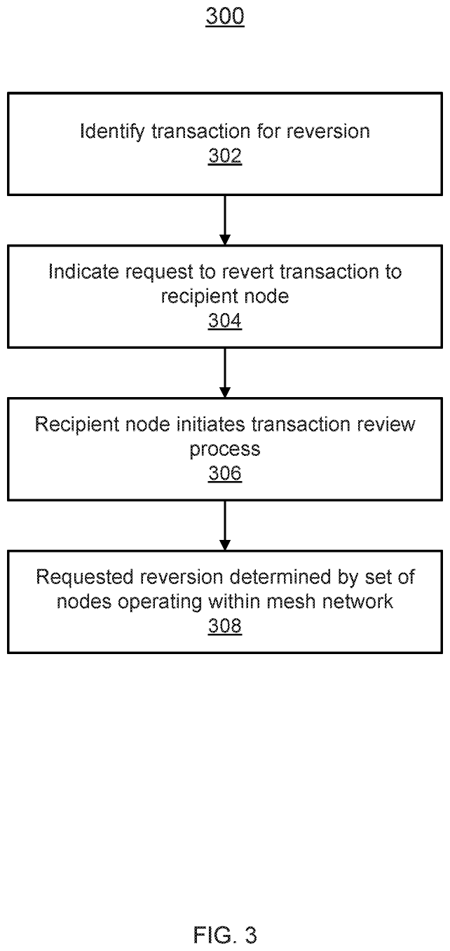

FIG. 3 illustrates an example of a logic flow 300 that may be representative of techniques for initiating a reversion of a transaction. For example, the logic flow 300 may be representative of operations that may be performed in various embodiments by any constituent component of the mesh network 100 (e.g., any of the nodes 102 such as the node 102-1) depicted in FIG. 1.

At 302, the node 102-1 can identify a transaction that the node 102-1 desires to reverse or revert. The transaction can be a fraudulent or unauthorized transaction. The transaction can be a mistake or an unintended transaction. In general, at 302, the node 102-1 can identify a transaction involving the cryptocurrency wallet of the node 102-1 and at least one other party (e.g., the node 102-5) that involved a first amount of a localized cryptocurrency. The first amount of the localized cryptocurrency can be previously minded on the localized mesh network 100. The node 102-5 can be the recipient of the transaction in that the node 102-5 received the first amount of the localized cryptocurrency from the cryptocurrency wallet of the first node 102-1 in exchange, for example, for a negotiated good, product, service or other item or provision. The transaction identified by the node 102-1 can already have occurred to the extent that the first amount of cryptocurrency has already been sent from the cryptocurrency wallet of the node 102-1 to the node 102-5. Accordingly, information regarding the transaction can be stored in the localized blockchain maintained within the localized mesh network 100.

At 304, the node 102-1 can communicate with the node 102-5. The node 102-5 can indicate that the node 102-1 requests that the identified transaction be reversed or reverted. In various embodiments, the node 102-1 can provide such indication to any other node 102 of the mesh network 100. In various embodiments, the node 102-1 can transmit a message requesting reversion of a transaction identified by the node 102-1. The message can identify a second node 102 of the mesh network 100. The identity of the second node 102 can be determined based on review of the localized blockchain. The message can provide additional details regarding the transaction including a time of the transaction and an amount of the cryptocurrency involved in the transaction, as well as a good or service involved in the transaction.

At 306, the node 102-5 can initiate a transaction review process. The node 102-5 and/or the node 102-1 can provide information to a set of nodes 102 operating within the mesh network 100 regarding the transaction. The set of nodes 102 can include only authorized nodes or can include unauthorized nodes. The set of nodes 102 can include the same set of nodes 102 that previously verified or authorized the transaction for which the node 102-1 is requesting reversion. The set of nodes 102 can receive a request to review the transaction and any information related to the transaction.

At 308, the set of nodes 102 can decide whether or not to grant the requested reversion of the transaction. The set of nodes 102 can include any number of nodes that operate on the mesh network 100. In general, the set of nodes 102 can typically include 2 to 7 nodes. The set of nodes 102 can decide by a vote whether or not to grant the requested reversion. In various embodiments, each node 102 can receive an equal vote (e.g., 1 vote for each node) or the nodes 102 can provide weighted votes (e.g., a first node can have a vote weight by a 1.5 scale factor and a second node can have a vote weighted by a 0.5 scale factor). In various embodiments, the decision on whether or not to grant to requested reversion can be decided based on a majority decision collectively made by the set of nodes 102. For example, each node 102 can provide a vote (e.g., yes or no as to reverting the transaction) with the transaction being reverted or not based on the majority rule of the vote.

In various embodiments, each node 102 separately or all of the nodes 102 collectively can decide their vote based on a scoring or trust level established for the requesting node 102-1. The node 102-1 can be scored as likely trustworthy or likely untrustworthy based on a variety of factors including, for example, a number of transactions conducted in total by the node 102-1 or involving the node 102-1, a number of transactions involving the node 102-1 that were requested to be reverted (either by the node 102-1 or by another node), a number of transactions involving the node 102-1 that were reverted or not reverted after a request for reversion, an amount of cryptocurrency held by the node 102-1, an amount of cryptocurrency involved in the transaction for which reversion is requested, an amount of time spent operating on the mesh network 100, etc.

In various embodiments, the set of nodes 102 can use the same criteria or different criteria for one another for providing a vote. In various embodiments, thresholds can be associated with each criterion with thresholds varying for each node 102 or the same for each node. For example, a first node 102 in the set of nodes 102 can determine the node 102-1 is not trustworthy if the node 102-1 has been involved in 5 or more requests for reversion and can vote against the requested reversion if the node 102-1 has been involved in 6 prior reversion requests (whether denied or granted). A second node 102 in the set of nodes 102 can determine the node 102-1 is not trustworthy if the node 102-1 has been involved in 3 or more requests for reversion and can vote against the requested reversion if the node 102-1 has been involved in 6 prior reversion requests (whether denied or granted). Accordingly, overall, criteria can be set to determine a score or level of trustworthiness of the node 102-1 with the criteria associated with a global or individual threshold level that can be exceeded or not exceeded so as to influence a vote to be provided by a node 102 within the set of nodes 102.

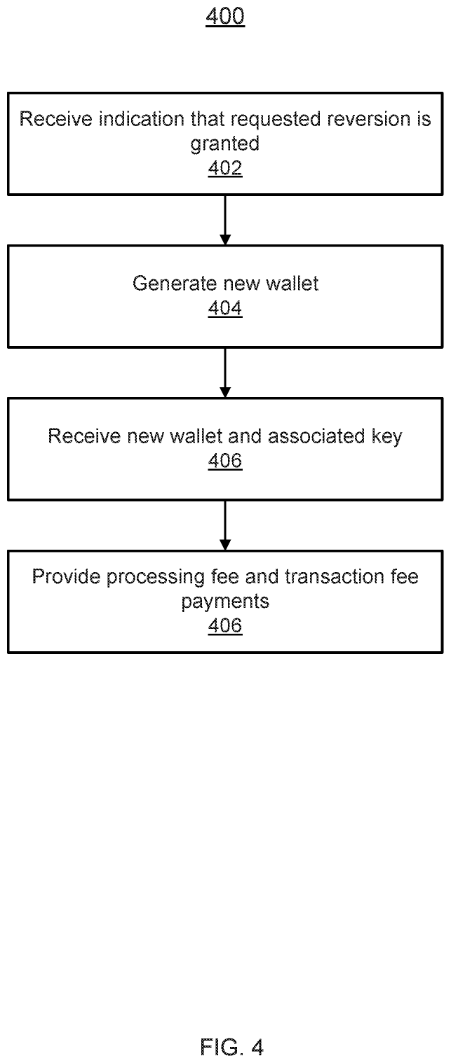

FIG. 4 illustrates an example of a logic flow 400 that may be representative of techniques for completing reversion of a transaction. For example, the logic flow 400 may be representative of operations that may be performed in various embodiments by any constituent component of the mesh network 100 (e.g., any of the nodes 102 such as the node 102-1) depicted in FIG. 1.

At 402, after determining to revert a transaction—for example, based on a process described in relation to FIG. 3—the node 102-1 can receive a message indicating that the requested reversion has been granted. The message can be transmitted by the node 102-5.

At 404, a new wallet can be generated for the node 102-1. The new wallet can be generated by the set of nodes 102 that were involved in determining whether or not to grant the requested reversion. Each node 102 in the set of nodes can perform a portion of the hashing used to create the new wallet. After the new wallet is created, the node 102-5 can verify the new wallet and/or the computing device functioning as the node 102-1.

At 406, the node 102-1 can receive the new wallet. The node 102-1 can also receive a new secret encryption key associated with the wallet. The wallet and associated key can be transmitted to the node 102-1 from the node 105-1 after each is prepared and/or created by the set of nodes 102 operating collectively.

At 408, the node 102-1 can provide a first payment or amount of cryptocurrency to the set of nodes 102 that granted the requested reversion (e.g., from the process described in relation to FIG. 3) and can provide a second payment or amount of cryptocurrency to the node 102-5 for handling the reversion process. The first and second amounts can be provided from the new wallet or the new wallet can be generated with these amounts removed from the wallet. In various embodiments, these amounts can be secured from the new wallet prior to the new wallet being provided to the node 102-1. The set of nodes 102 can receive a reversion transaction fee for creating the new wallet and/or key. The node 102-5 can receive a recovering processing fee for overseeing the creation of the new wallet and/or key. The first and second amount can be less than an amount of cryptocurrency involved in the reverted transaction.

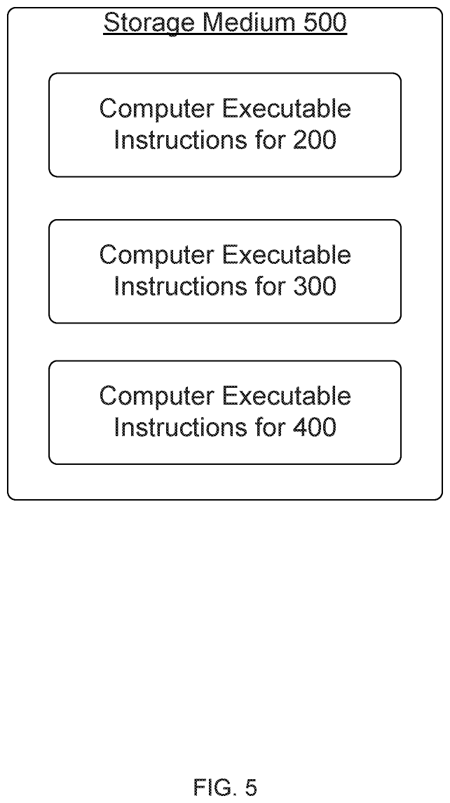

FIG. 5 illustrates a storage medium 500. Storage medium 500 may represent an implementation of a storage device of any electronic device and/or computing device that may operate as a node within the mesh network 100 of FIG. 1. The storage medium 500 can comprise any non-transitory computer-readable storage medium or machine-readable storage medium. In various embodiments, the storage medium 500 can comprise a physical article of manufacture. In various embodiments, storage medium 500 can store computer-executable instructions, such as computer-executable instructions to implement one or more of logic flows or operations described herein, such as the logic flow 200 of FIG. 2, the logic flow 300 of FIG. 3, and/or the logic flow 400 of FIG. 4.

In various embodiments, storage medium 500 can store computer-executable instructions, such as computer-executable instructions to implement any of the functionality described herein in relation to any described device, system, or apparatus. Examples of a computer-readable storage medium or machine-readable storage medium can include any tangible media capable of storing electronic data. Examples of computer-executable instructions can include any type of computer readable code.

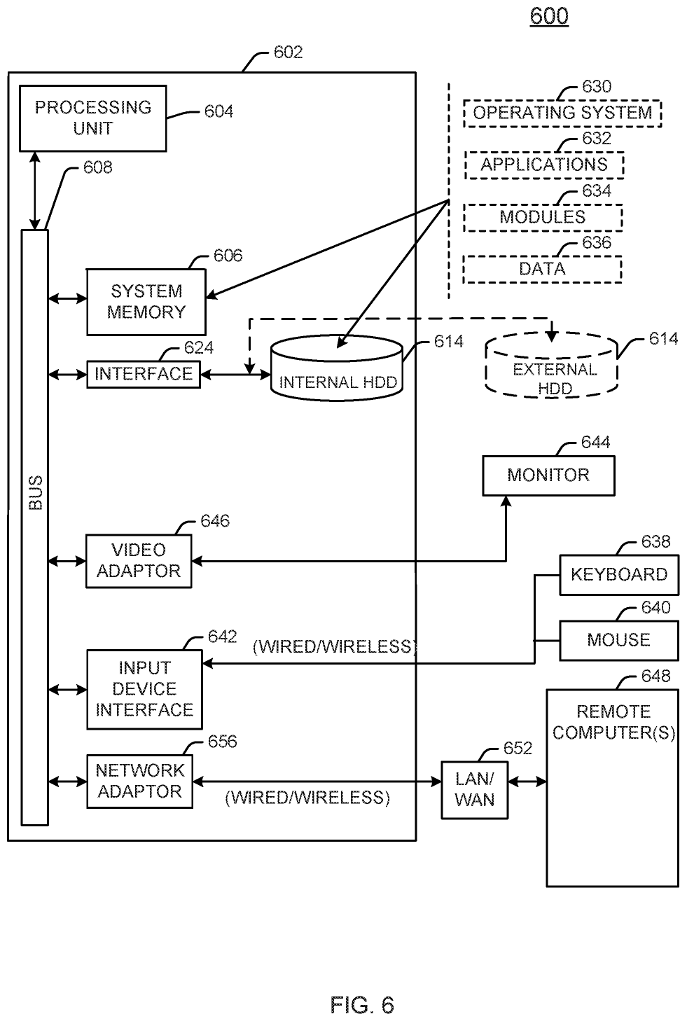

FIG. 6 illustrates a computing architecture 600 that can implement various embodiments described herein. In various embodiments, the computing architecture 600 can comprise or be implemented as part of an electronic device and/or a computing device. In various embodiments, the computing architecture 600 can represent an implementation of any constituent component of the mesh network 100 depicted in FIG. 1. One or more of the constituent components of the computing architecture 600, and/or any constituent component of the mesh network 100, can be implemented in hardware, software, or any combination thereof including implementation based on a storage device (e.g., a memory unit) and logic, at least a portion of which is implemented in circuitry and coupled to the storage device. The logic can be or can include a processor or controller component.

The computing architecture 600 can include various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth.

As shown in FIG. 6, the computing architecture 600 can comprise a computer 602 having a processing unit 604, a system memory 606 and a system bus 608. The processing unit 604 can be any of various commercially available processors or can be a specially designed processor.

The system bus 608 provides an interface for system components including, but not limited to, an interface between the system memory 606 and the processing unit 604. The system bus 608 can be any of several types of bus structure that may further interconnect to a memory bus (with or without a memory controller), a peripheral bus, and a local bus using any of a variety of commercially available bus architectures.

The system memory 606 can include any type of computer-readable storage media including any type of volatile and non-volatile memory. The computer 602 can include any type of computer-readable storage media including an internal (or external) hard disk drive (HDD) 614. In various embodiments, the computer 602 can include any other type of disk drive such as, for example, a magnetic floppy disk and/or an optical disk drive. The HDD 614 can be connected to the system bus 608 by a HDD interface 624.

In various embodiments, any number of program modules can be stored in the drives and memory units 606 and/or 614 such as, for example, an operating system 630, one or more application programs 632, other program modules 634, and program data 636.

A user can enter commands and information into the computer 602 through one or more wired/wireless input devices such as, for example, a keyboard 638 and a pointing device, such as a mouse 640. These and other input devices can be connected to the processing unit 604 through an input device interface 642 that is coupled to the system bus 608. A monitor 644 or other type of display device can also be connected to the system bus 608 via an interface, such as a video adaptor 646. The monitor 644 may be internal or external to the computer 602

The computer 602 may operate in a networked environment using logical connections via wired and/or wireless communications to one or more remote computers, such as a remote computer 648. The remote computer 648 can be a workstation, a server computer, a router, a personal computer, portable computer, microprocessor-based entertainment appliance, a smartphone, a tablet, a peer device or other common network node, and typically includes many or all of the elements described relative to the computer 602. The logical connections depicted include wired and/or wireless connectivity to networks 652 such as, for example, a local area network (LAN) and/or larger networks, for example, a wide area network (WAN). Networks 652 can provide connectivity to a global communications network such as, for example, the Internet. A network adapter 656 can facilitate wired and/or wireless communications to the networks 652. The computer 602 is operable to communicate over any known wired or wireless communication technology, standard, or protocol according to any known computer networking technology, standard, or protocol.

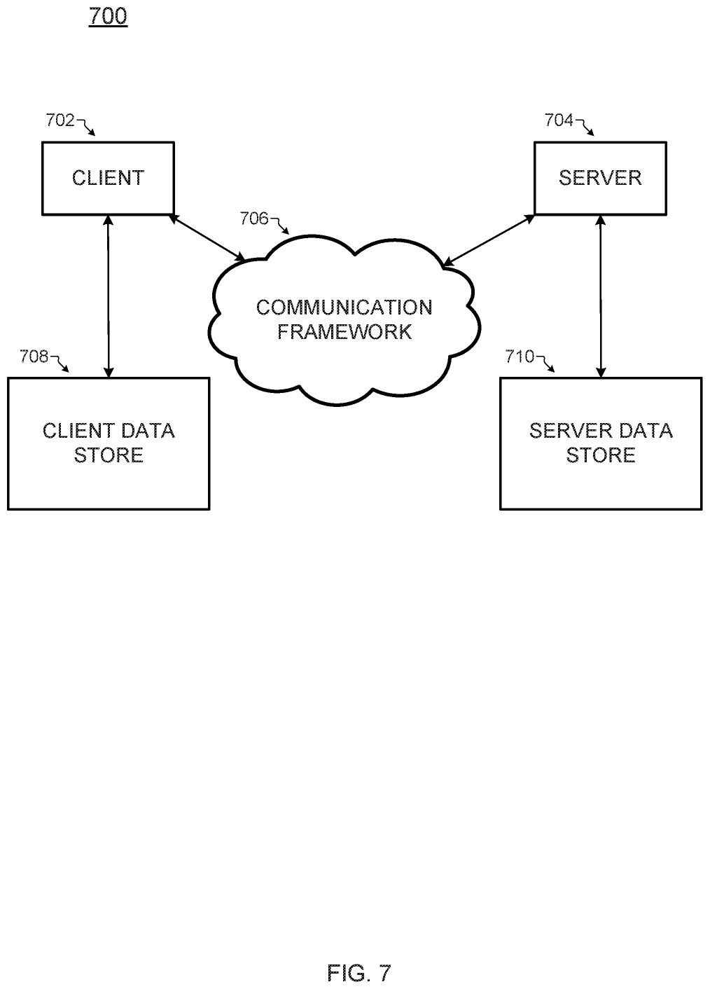

FIG. 7 illustrates a block diagram of a communication architecture 700. The communication architecture 700 can implement various embodiments described herein. As shown in FIG. 7, the communication architecture 700 comprises one or more clients 702 and servers 704. One of the clients 702 and/or one of the servers 704 can represent any constituent component of the mesh network 100 depicted in FIG. 1.

The client 702 and the server 704 can be operatively connected to a client data store 708 and a server data store 710, respectively, that can be employed to store information local to the respective client 702 and server 704. In various embodiments, the client 702 and/or the server 704 can implement one or more of logic flows or operations described herein.

The client 702 and the server 704 can communicate data or other information between each other using a communication framework 706. The communications framework 706 can implement any known communications technique or protocol. The communications framework 706 can be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators), or any combination thereof. The communications framework 706 can operate over any communication media according to any networking technology including any wired or wireless communications standard or protocol, or any combination thereof.

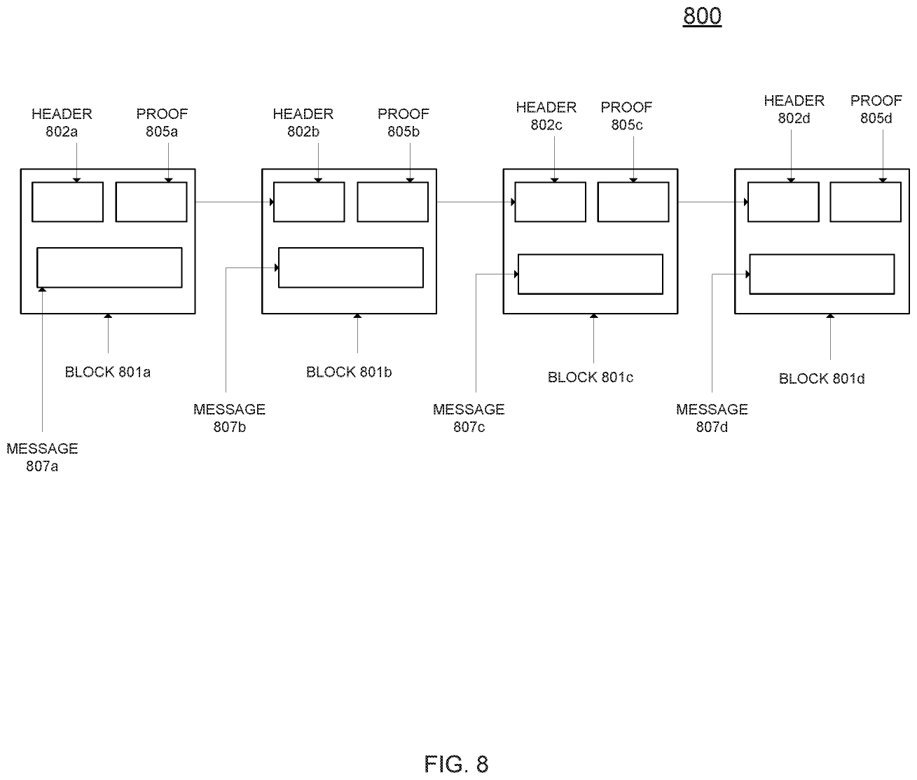

FIG. 8 depicts a logical model 800 of an exemplary blockchain, consistent with disclosed embodiments. The blockchain may represent one or more of the blockchains described herein such as, for example, a blockchain that stores searchable transactions related to transactions conducted within the mesh network 100. The blockchain may comprise blocks, such as blocks 801a-801d. Blocks may include messages, such as message 807a-807d. Generally, blocks may include a header, such as headers 802a-802d, which uniquely identifies each block. The headers 802a-802d may include a hash value generated by a hash function. A hash function is any function that can be used to map input data of arbitrary size to a hash value of a fixed size. For example, a header may include at least one of the previous block's hash value, a hash value generated based on any messages in the block (e.g., a Merkle root), and a timestamp. Consistent with disclosed embodiments, blocks added to a blockchain described herein may satisfy at least one of a proof-of-work condition and a digital signature condition. For example, the headers 802a-802d may include a nonce chosen to ensure the header satisfies the proof-of-work condition. As a non-limiting example, the proof-of-work condition may require the hash of the header fall within a predetermined range of values. As an additional example, the header may be digitally signed with a cryptographic key of an authorized system (e.g., an authorized node 102), and the digital signature may be included in the header. This digital signature may be verified using an available key. The blocks may also include proof components, such as proof components 805a-805d. As an example, the nonce can comprise the proof components 805.

In various embodiments, the blocks 801 can store information related to transactions conducted by nodes on the mesh network 100. The blocks 801 can store information indicating the parties/nodes 102 involved in a transaction, an amount of cryptocurrency involved in the transaction, a time of the transaction, and any other information related to the transaction (e.g., what good or service was purchased during the transaction).

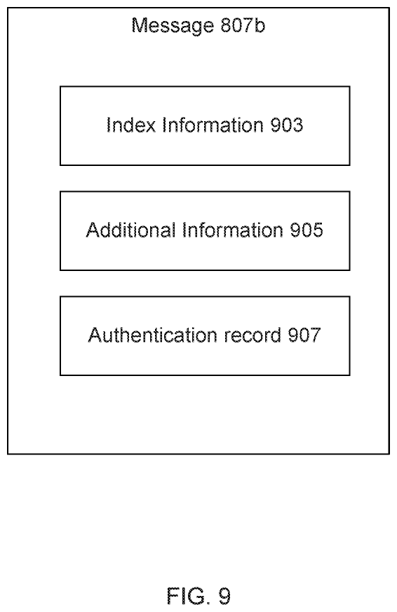

FIG. 9 depicts a logical model of a message 807b stored in a blockchain (e.g., an element of blockchain depicted in FIG. 8), consistent with disclosed embodiments. In various embodiments, the messages 807 can be considered the records stored in relation to hosted content. In some embodiments, message 807b may comprise index information 903. In certain aspects, index information 903 may comprise information identifying a user. For example, index information 903 may be at least one of a full name, email address, phone number, or other non-sensitive personal information of the user. In various aspects, index information 903 may include one or more references to earlier blocks in the private blockchain. For example, index information 903 may include one or more references to one or more earlier blocks associated with the same user. A reference may include, as a non-limiting example, a hash of a preceding block in the blockchain associated with the same user. In some aspects, index information 903 may be obfuscated or encrypted according to methods known to one of skill in the art. For example, index information 903 may be encrypted with a cryptographic key. As an additional example, index information 903 may comprise a hash of the at least one of a full name, email address, phone number, or other non-sensitive personal information of the user.

Message 807b may comprise additional information 905, consistent with disclosed embodiments. The additional information 905 can be, for example, metadata or other information related to transactions conducted on the mesh network 100 using a localized cryptocurrency as described herein.

Message 807b may comprise authentication record 907, consistent with disclosed embodiments. In some aspects, authentication record 907 may comprise information enabling subsequent auditing of transactions. For example, authentication record 907 may identify at least one node of the mesh network 100. In some aspects, authentication record 907 may be obfuscated or encrypted according to methods known to one of skill in the art. For example, authentication record 907 may be encrypted with a cryptographic key.

Cryptographic keys may be used to encrypt elements of messages in blocks, consistent with disclosed embodiments. In some aspects, such cryptographic keys may be associated with nodes of the mesh network 100. In various aspects, at least some of the cryptographic keys may be associated with authorized nodes 102. Corresponding cryptographic keys may be available to decrypt the encrypted message elements, consistent with disclosed embodiments. For example, when an element of a message in a block is encrypted with a symmetric key, the same symmetric key may be available for decrypting the encrypted element. As another example, when an element of a message in a block is encrypted with a private key, a corresponding public key may be available for decrypting the encrypted element, or when an element of a message in a block is encrypted with a public key, a corresponding private key may be available for decrypting the encrypted element. In various embodiments, signatures included for each block 801 can be encrypted and can be decrypted by nodes 102 of the mesh network 100.

Various embodiments described herein may comprise one or more elements. An element may comprise any structure arranged to perform certain operations. Each element may be implemented as hardware, software, or any combination thereof. Any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

In various instances, for simplicity, well-known operations, components, and circuits have not been described in detail so as not to obscure the embodiments. It can be appreciated that the specific structural and functional details disclosed herein may be representative and do not necessarily limit the scope of the embodiments.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

1. An electronic device, comprising:
a storage device;
memory coupled with the storage device, the memory to store instructions;
circuitry coupled with the storage device and the memory, enabled to execute the instructions, that when executed, cause the circuitry to:
establish the electronic device as capable of operating as a first authorized node on a localized mesh network, the first authorized node associated with an initial cryptocurrency wallet and the localized mesh network comprising a set of unauthorized nodes and a set of authorized nodes, wherein the set of unauthorized nodes are prohibited from performing transactions on the localized mesh network, and the set of authorized nodes are enabled to perform transactions, authorize transactions based on voting, and revert transactions based on voting;
transmit a first message requesting reversion of a transaction involving a second authorized node on the localized mesh network, the transaction involving a first amount of a localized cryptocurrency previously maintained within the initial cryptocurrency wallet;
receive a second message indicating grant of the requested reversion of the transaction by the set of authorized nodes on the localized mesh network, wherein the set of authorized nodes to grant the requested reversion based on a vote provided by each node in the set authorized of nodes; and
receive an indication that the second authorized node confirms issuance of a replacement cryptocurrency wallet for the initial cryptocurrency wallet to revert the transaction.

2. The electronic device of claim 1, wherein the set of authorized nodes previously verified the transaction prior to the requested reversion of the transaction.

3. (canceled)

4. The electronic device of claim 1, wherein the vote provided by each node is based on a determined level of trust associated with the first authorized node, the determined level of trust based on a number of prior requested transaction reversions.

5. The electronic device of claim 1, the circuitry to:
receive data relating to the localized mesh network and store the received data in the storage device of the electronic device;
generate the initial cryptocurrency wallet and store the generated initial cryptocurrency wallet in the storage device; and
load the generated cryptocurrency wallet with the first amount of the localized cryptocurrency.

6. The electronic device of claim 1, wherein the set of authorized nodes on the localized mesh network store a second amount of the localized cryptocurrency that is above a first threshold amount or conduct a number of transactions within the localized mesh network involving the localized cryptocurrency that is above a first threshold number.

7. The electronic device of claim 1, wherein the replacement cryptocurrency wallet stores a second amount of the localized cryptocurrency, the second amount of the localized cryptocurrency less than the first amount of the localized cryptocurrency.

8. The electronic device of claim 7, wherein a first portion of a difference between the first amount of the localized cryptocurrency and the second amount of the localized cryptocurrency is provided to the set of authorized nodes as a fee for reverting the transaction.

9. The electronic device of claim 8, wherein a second portion of the difference between the first amount of the localized cryptocurrency and the second amount of the localized cryptocurrency is provided to the second node.

10. A method, comprising:
establishing an electronic device as capable of operating as a first node on a mesh network and the mesh network comprising a set of unauthorized nodes and a set of authorized nodes, wherein the set of unauthorized nodes are prohibited from performing transactions on the mesh network, and the set of authorized nodes are enabled to perform transactions, authorize transactions based on voting, and revert transactions based on voting;
associating the first node with an initial cryptocurrency wallet;
transmitting a first message requesting reversion of a transaction involving a second node on the mesh network, the transaction involving a first amount of a localized cryptocurrency previously maintained within the initial cryptocurrency wallet;
receiving a second message indicating grant of the requested reversion of the transaction by the set of authorized nodes on the mesh network, wherein the set of authorized nodes grant the requested reversion based on a vote provided by each node in the set authorized of nodes; and
receiving an indication that the second node confirms issuance of a replacement cryptocurrency wallet for the initial cryptocurrency wallet to revert the transaction.

11. The method of claim 10, wherein the set of authorized nodes previously verified the transaction prior to the requested reversion of the transaction.

12. (canceled)

13. The method of claim 10, wherein the replacement cryptocurrency wallet stores a second amount of the localized cryptocurrency, the second amount of the localized cryptocurrency less than the first amount of the localized cryptocurrency.

14. The electronic device of claim 13, wherein a first portion of a difference between the first amount of the localized cryptocurrency and the second amount of the localized cryptocurrency is provided to the set of authorized nodes as a fee for reverting the transaction.

15. The electronic device of claim 14, wherein a second portion of the difference between the first amount of the localized cryptocurrency and the second amount of the localized cryptocurrency is provided to the second node.

16. At least one non-transitory computer-readable medium comprising a set of instructions that, in response to being executed on a computing device, cause the computing device to:
establish the computing device as capable of operating as a first node on a mesh network, the first node associated with an initial cryptocurrency wallet and the mesh network comprising a set of unauthorized nodes and a set of authorized nodes, wherein the set of unauthorized nodes are prohibited from performing transactions on the mesh network, and the set of authorized nodes are enabled to perform transactions, authorize transactions based on voting, and revert transactions based on voting;
transmit a first message requesting reversion of a transaction involving a second node on the mesh network, the transaction involving a first amount of a localized cryptocurrency previously maintained within the initial cryptocurrency wallet;
receive a second message indicating grant of the requested reversion of the transaction by a set of authorized nodes on the mesh network, wherein the set of authorized nodes to grant the requested reversion based on a vote provided by each node in the set authorized of nodes; and
receive an indication that the second node confirms issuance of a replacement cryptocurrency wallet for the initial cryptocurrency wallet to revert the transaction.

17. The at least one non-transitory computer-readable medium of claim 16, wherein the set of authorized nodes previously verified the transaction prior to the requested reversion of the transaction.

18. (canceled)

19. The at least one non-transitory computer-readable medium of claim 16, wherein the replacement cryptocurrency wallet stores a second amount of the localized cryptocurrency, the second amount of the localized cryptocurrency less than the first amount of the localized cryptocurrency.

20. The at least one non-transitory computer-readable medium of claim 19, wherein a first portion of a difference between the first amount of the localized cryptocurrency and the second amount of the localized cryptocurrency is provided to the set of nodes as a fee for reverting the transaction and a second portion of the difference between the first amount of the localized cryptocurrency and the second amount of the localized cryptocurrency is provided to the second node.

21. The electronic device of claim 1, wherein each node of the set of authorized nodes authorized based on storing an amount of cryptocurrency above a specified amount, and wherein the unauthorized nodes are enabled to communicate messages within the localized mesh network and receive fees for communicating of messages.

22. The electronic device of claim 1, wherein each node of the set of authorized nodes authorized based a number of votes by authorized nodes above a specified number of authorization votes, and wherein the unauthorized nodes are enabled to communicate messages within the localized mesh network and receive fees based communication of messages.

23. The electronic device of claim 1, wherein each node of the set of authorized nodes authorized based on a number of transactions processed by a node above a specified transaction amount, and wherein the unauthorized nodes are enabled to communicate messages within the localized mesh network and receive fees based on communication of messages.
